(19) United States
(12) Patent Application Publication
(10) Pub. No.: US 2026/0327377 A1
(43) Pub. Date: Oct. 22, 2026

(54) SOLVENT-SOLUBLE POLYIMIDE AND METHOD FOR PREPARING THE SAME

(71) Applicant: PI ADVANCED MATERIALS CO., LTD., Jincheon-gun, Chungcheongbuk-do (KR)

(72) Inventors: Kyuwon LEE, Jincheon-gun (KR); Jeong Jae HWANG, Jincheon-gun (KR); Han Tae RYU, Jincheon-gun (KR); Kil Nam LEE, Jincheon-gun (KR)

(21) Appl. No.: 19/486,853

(22) PCT Filed: May 14, 2024
(86) PCT No.: PCT/KR2024/006540

§ 371 Date: Nov. 21, 2025

(30) Foreign Application Priority Data
May 30, 2023 (KR) 10-2023-0069538

(51) Int. Cl. C08G 73/10; C08J 5/18

(52) U.S. Cl. CPC C08G 73/1067; C08G 73/1028; C08G 73/1042; C08J 5/18; C08J 2379/08

(57) ABSTRACT

The present disclosure provides a polyimide comprising: as polymerized units, a dianhydride monomer; and a diamine monomer including 4,4′-methylenebis(2,6-diethylaniline) (MEDA), wherein the polyimide is a random copolymer in which the polymerized units are irregularly arranged.

### TECHNICAL FIELD

The present disclosure relates to a solvent-soluble polyimide and a method for preparing the same. More particularly, the present disclosure relates to a polyimide having excellent thermal and mechanical properties and soluble properties in an organic solvent, and a method for preparing the same.

### BACKGROUND ART

In general, polyimide (PI) is based on an imide ring having excellent chemical stability together with a rigid aromatic main chain, and is a polymer material with the highest level of heat resistance, chemical resistance, electrical insulation, chemically resistant property, and weather resistance among organic materials, thereby being prepared into various forms such as films, fibers, membranes, etc. Due to these characteristics, polyimide is used, as an advanced material and insulation coating agent, in a wide range of fields such as electrical and electronics, semiconductors, displays, automobiles, aviation, and space materials.

Polyimide may be prepared by dissolving, in a solvent, acid dianhydride having two acid anhydride groups in its molecule and diamine having two amino groups in its molecule to synthesize a polyimide precursor called polyamic acid (PAA), and applying and drying the polyimide precursor, followed by heat treatment at about 350 °C to perform imidization. Since there has been a high demand to handle polyimide in a solution state, and a lot of development is underway on solvent-soluble polyimide.

However, conventional polyimide prepared by imidization through dehydration and ring closure reaction using conventional chemical method or high temperature method had insoluble properties in solvents, causing a difficulty in processing. In addition, in order to prepare polyimide soluble in solvents, in general, there is no choice but to use highly soluble monomers, but these monomers generally have low heat resistance, and thus the prepared polyimide has a problem of low heat resistance and low chemical resistance. Meanwhile, in order to use polyimide in the form of a solution while having heat resistance or chemical resistance, there is a method of preparing polyimide by forming a coating film with a polyamic acid solution, which is a polyimide precursor, and then performing imidization.

However, the polyamic acid solution has the disadvantages of being vulnerable to humidity and difficult to handle and store, and requiring a heat treatment process at high temperature to imidize the polyamic acid.

Under this background, there is a need to develop polyimide capable of maintaining the high heat resistance and insulation properties thereof, while being easily soluble in organic solvents and capable of preparing polyimide-based products only by solvent drying without an imidization process at high temperature.

### DISCLOSURE OF INVENTION

### Technical Problem

An object of the present disclosure is to provide a polyimide (PI) that exhibits soluble properties in an organic solvent and has excellent thermal and mechanical properties.

Another object of the present disclosure is to provide a polyimide, which is fully imidized, capable of being prepared in various ways, such as films and fibers, etc., simply by drying a solvent without an imidization process at high temperature.

Still another object of the present disclosure is to provide a polyimide solution comprising the polyimide.

In addition, still another object of the present disclosure is to provide polyimide powder comprising the polyimide.

In addition, still another object of the present disclosure is to provide a polyimide film comprising the polyimide.

Further, still another object of the present disclosure is to provide various forms of polyimides, such as separators, binders, insulation coatings, and coating materials comprising the polyimide.

Further, still another object of the present disclosure is to provide a method for preparing the polyimide.

### Solution to Problem

Various modifications can be made and various embodiments may be implemented in the present disclosure, and specific embodiments are illustrated in the drawings and described in detail. However, these embodiments are not intended to limit the present disclosure to specific embodiments, and should be understood to comprise all modifications, equivalents, and substitutes included in the spirit and scope of the present disclosure.

Terms used in the present application are only used to describe specific embodiments and are not intended to limit the present disclosure. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

When ranges of numerical values are stated herein, unless otherwise stated, it is intended that the endpoints of the range and the scope of the parent invention within the range are not limited to the specific values stated when defining the range.

As used herein, “dianhydride” is intended to include precursors or derivatives thereof, which are also referred to as “dianhydride” or “acid dianhydride”. These products may technically not be dianhydrides, but will nonetheless react with diamines to form polyamic acids, and the polyamic acids may be converted back into polyimides.

As used herein, “diamine” is intended to include precursors or derivatives thereof, which may technically not be diamines, but will nonetheless react with dianhydride acid to form a polyamic acid, and the polyamic acid may be converted back into polyimide.

Further, unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in the present application, it is not to be construed in an idealized or overly formal sense. Specific details for the implementation of the invention will be described below.

The present disclosure relates to a polyimide (PI) with soluble properties in an organic solvent.

### Polyimide

In one general aspect, there is provided a polyimide comprising: as polymerized units, a dianhydride monomer; and a diamine monomer including 4,4′-methylenebis(2,6-diethylaniline) (MEDA), wherein the polyimide is a random copolymer in which the polymerized units are irregularly arranged.

The random copolymer is a copolymer composed of three or more types of polymerized units (repeating units), wherein the order of the polymerized units is randomly connected. For example, the expression “-(A)a-(B)b-(C)c-(D)d-”, which is a random copolymer of polymerized units A to D, means that the polymerized units are randomly connected in various forms, such as -(A-B-A-D-A-B-A-B-C)-, -(A-A-C-C-C-B-B-D-B)-, -(A-A-D-A-B-A-D-A-B-A-C-C)-, and the like, wherein a, b, c, and d are the proportions of polymerized units A, B, C, and D, respectively.

The dianhydride monomer may comprise at least one selected from the group consisting of 3,3′,4,4′-benzophenone tetracarboxylic dianhydride (BTDA), oxydiphthalic dianhydride (ODPA), 4,4′-(hexafluoroisopropylidene)diphthalic anhydride (6FDA), biphenyltetracarboxylic dianhydride (BPDA), and 3,3′,4,4′-diphenylsulfone tetracarboxylic dianhydride (DSDA). More specifically, the dianhydride monomer may be any one or a combination of two or more of the above-described dianhydride monomers. More specifically, the dianhydride monomer is preferably composed of one type. More specifically, the dianhydride monomer preferably comprises 3,3′,4,4′-benzophenone tetracarboxylic dianhydride (BTDA).

The diamine monomer may further include at least one selected from the group consisting of 2,4-diaminotoluene (2,4-TDA), 2,6-diaminotoluene (2,6-TDA), m-phenylenediamine (m-PD), and p-phenylenediamine (p-PD). More specifically, the diamine monomer may be a combination that further comprise any one or two or more of the above-described diamine monomers. More specifically, the diamine monomer preferably further includes one type. More specifically, the diamine monomer preferably includes 2,4-diaminotoluene (2,4-TDA).

In an embodiment, the polyimide may comprise, as polymerized units, the dianhydride monomer, 3,3′,4,4′-benzophenone tetracarboxylic dianhydride (BTDA); and the diamine monomers, 4,4′-methylenebis(2,6-diethylaniline) (MEDA) and 2,4-diaminotoluene (2,4-TDA).

An amount of the 4,4′-methylenebis(2,6-diethylaniline) (MEDA) in the total diamine monomers may be more than 0 mol % and less than or equal to 15 mol %. For example, the upper limit thereof may be 15 mol % or less, 14 mol % or less, 13 mol % or less, 12 mol % or less, 11 mol % or less, and the lower limit thereof may be 0.1 mol % or more, 0.5 mol % or more, 1 mol % or more, 2 mol % or more, 3 mol % or more, 4 mol % or more. Specifically, an amount of the MEDA may be 3 to 12 mol %.

An amount of the 2,4-diaminotoluene (2,4-TDA) in the total diamine monomers may be 85 mol % or more and less than 100 mol %. For example, the lower limit thereof may be 85 mol % or more, 86 mol % or more, 87 mol % or more, 88 mol % or more, 89 mol % or more, and the upper limit thereof may be 99.9 mol % or less, 99.5 mol % or less, 99 mol % or less, 98 mol % or less, 97 mol % or less, 96 mol % or less. Specifically, an amount thereof may be 88 to 97 mol %.

The polyimide may comprise the diamine monomers in an amount of 90 to 110 mol %, preferably 95 to 105 mol %, and more preferably 100 mol %.

The polyimide may comprise the dianhydride monomer in an amount of 90 to 110 mol %, preferably 95 to 105 mol %, and more preferably 100 mol %.

The polyimide may comprise the dianhydride monomer and the diamine monomer in a molar ratio of 1:2 to 2:1, preferably in a molar ratio of 1:1.

The polyimide has excellent solubility in an organic solvent for a solid content of 15 wt %, 16 wt %, 17 wt %, 18 wt %, 19 wt %, 20 wt %, 21 wt %, 22 wt %, 23 wt %, 24 wt %, or 25 wt % or more. In an embodiment, the degree of turbidity of the solution was visually confirmed by adding 20 wt % of polyimide solid content at room temperature, followed by stirring for 30 minutes.

The organic solvent may be an aprotic polar organic solvent, and specifically, may comprise at least one selected from the group consisting of N-methyl-pyrrolidone (NMP), N,N′-dimethylformamide (DMF), N,N′-diethylformamide (DEF), N,N′-dimethylacetamide (DMAc), dimethylpropanamide (DMPA), and N,N-diethylacetamide (DEAc).

In the present disclosure, a thermal decomposition temperature (Td) and a glass transition temperature (Tg) were measured, in which the thermal decomposition temperature is mainly used as a standard for judging thermal properties of polyimide, and the glass transition temperature is able to predict thermal properties while also determining mechanical properties.

The thermal decomposition temperature (Td) at 5% weight loss of the polyimide may be 485 °C or higher. For example, the lower limit of the thermal decomposition temperature of the polyimide may be 487±1 °C, 490±1 °C, 493±1 °C, 495±1 °C or 496±1 °C or higher. The thermal decomposition temperature may be measured using TA's thermogravimetric analyzer Q50. In a specific example, the polyimide may be heated up to 100 °C at a rate of 10 °C/min under a nitrogen atmosphere and then maintained isothermally for 1 hour to remove moisture. Then, the temperature at which a 5% weight loss occurs by heating up to 600 °C at a rate of 10 °C/min may be measured.

The glass transition temperature (Tg) of the polyimide may be 300 °C or higher. For example, the lower limit of the glass transition temperature may be 305±1 °C, 310±1 °C, 312±1 °C, 315±1 °C, 317±1 °C or 318±1 °C or higher. The glass transition temperature may be measured for polyimide at 5 °C/min using dynamic mechanical analysis (DMA).

The polyimide of the present disclosure is characterized by excellent solubility in an organic solvent while maintaining excellent thermal properties.

By irregularly arranging the polymerized units, the polyimide of the present disclosure is able to achieve heat resistance and soluble properties in a solvent by reducing the MEDA amount to 15 mol % or less. Accordingly, the polyimide may be easily soluble in an organic solvent to be able to be prepared into films, fibers, and the like, simply by drying the solvent without an imidization process at high temperature.

Further, the polyimide film may have a tensile strength of 90 MPa or more, preferably 95 MPa or more, and the upper limit thereof is not particularly limited, but may be 400 MPa or less. The tensile strength was measured using an Instron 5564 UTM apparatus from INSTRON.

The polyimide film may have a modulus of 2.5 GPa or more, preferably 3 GPa or more. The modulus was measured using an Instron 5564 UTM apparatus from INSTRON.

The polyimide film may have an elongation of 3.5% or more, preferably 4.0% or more. The elongation was measured using an Instron 5564 UTM apparatus from INSTRON.

In another general aspect, there is provided a polyimide solution comprising the polyimide and an organic solvent.

The polyimide of the present disclosure has excellent solubility in an organic solvent, which has an advantage in that it can be easily used for polyimide films, fibers, or coating by using the polyimide in the form of a solution dissolved in an organic solvent.

In the present disclosure, the polyimide solution may have a polyimide solid content of 15 to 50 wt % based on 100 parts by weight of the polyimide solution. The lower limit for wt % of the solid content may be 16, 17, 18, 19, or 20 wt % or more, and the upper limit for wt % of the solid content may be 45, 40, 35, 30, 27, or 25 wt % or less. By adjusting the solid content of the polyimide solution, it is possible to control the increase in viscosity and to shorten the processing time during the curing process.

In an exemplary embodiment, the polyimide solution of the present disclosure may have a viscosity in the range of 200 to 30,000 cP, the viscosity being measured at a temperature of 23 °C and a shear rate of 1 s⁻¹. Specifically, the lower limit of the viscosity of the polyimide solution may be 300 cP or more, 400 cP or more, 500 cP or more, 600 cP or more, 700 cP or more, or 800 cP or more. The upper limit thereof may be 20,000 cP or less, 15,000 cP or less, 10,000 cP or less, 9,000 cP or less, 8,000 cP or less, 7,000 cP or less, 6,500 cP or less, 6,300 cP or less, or 6,100 cP or less. It is possible to prepare a cured polyimide product with excellent processability and desired physical properties, by adjusting the viscosity range of the polyimide solution. The viscosity is a viscosity of 20 wt % of the polyimide solid content that is re-dissolved in an organic solvent.

In still another aspect, there is provided polyimide powder comprising the polyimide of the present disclosure.

In still another aspect, there is provided a polyimide film comprising the polyimide of the present disclosure.

A thickness of the polyimide film may be appropriately selected in consideration of the use of the polyimide film, the use environment, physical properties, and the like. For example, the polyimide film may have a thickness of 1 to 100 μm, 5 to 50 μm, 10 to 40 μm, or 15 to 25 μm, but is not limited thereto.

Further, in still another aspect, there is provided a component comprising a molded body formed from the polyimide.

Specifically, the component may comprise, but not limited to, electronic circuit board members, semiconductor devices, lithium ion battery members, solar cell members, fuel cell members, motor windings, engine peripheral members, paints, optical components, heat insulators, electromagnetic shielding materials, surge components, dental materials, slide coating, and electrostatic chuck.

In addition, in still another aspect, there is provided a separator (membrane) comprising the polyimide as described above.

Further, in still another aspect, there is provided a fiber comprising the polyimide as described above.

In addition, in still another aspect, there is provided an insulation layer comprising the polyimide as described above.

Further, in still another aspect, there is provided a coating layer comprising the polyimide as described above.

### Method for Preparing Polyimide

There is provided a method for preparing a polyimide comprising: (a) adding a dianhydride monomer to a diamine monomer including 4,4′-methylenebis(2,6-diethylaniline) (MEDA); and (b) performing random-polymerization on the diamine monomer and the dianhydride monomer.

The dianhydride monomer may comprise at least one selected from the group consisting of 3,3′,4,4′-benzophenone tetracarboxylic dianhydride (BTDA), oxydiphthalic dianhydride (ODPA), 4,4′-(hexafluoroisopropylidene)diphthalic anhydride (6FDA), biphenyltetracarboxylic dianhydride (BPDA), and 3,3′,4,4′-diphenylsulfone tetracarboxylic dianhydride (DSDA).

The diamine monomer may further include at least one selected from the group consisting of 2,4-diaminotoluene (2,4-TDA), 2,6-diaminotoluene (2,6-TDA), m-phenylenediamine (m-PD), and p-phenylenediamine (p-PD).

The step (a) may comprise: (a-1) dissolving a diamine monomer including 4,4′-methylenebis(2,6-diethylaniline) (MEDA) in an organic solvent; and (a-2) adding a dianhydride monomer to the dissolved diamine monomer.

Specifically, the step (a) may be a step of dissolving the total diamine monomers in an organic solvent, followed by adding and dissolving the total dianhydride monomers.

The random polymerization of step (b) may be performed for 10 to 120 minutes, preferably for 30 to 100 minutes, and more preferably for 50 to 70 minutes.

In an embodiment, a polyamic acid (PAA) may be prepared by the random polymerization of the diamine monomer and the dianhydride monomer, wherein the polyamic acid may have a viscosity in the range of 200 to 30,000 cP, the viscosity being measured at a temperature of 23 °C and a shear rate of 1 s⁻¹. Specifically, the lower limit of the viscosity of the polyimide solution may be 300 cP or more, 400 cP or more, 500 cP or more, 600 cP or more, 700 cP or more, or 800 cP or more. The upper limit thereof may be 20,000 cP or less, 15,000 cP or less, 10,000 cP or less, 9,000 cP or less, 8,000 cP or less, 7,000 cP or less, 6,500 cP or less, 6,300 cP or less, or 6,100 cP or less. It is possible to prepare a polyimide solution and/or a cured polyimide product with excellent processability and desired physical properties, by adjusting the viscosity range of the polyamic acid.

In step (b), the polyamic acid may be prepared by polymerizing the diamine monomer and the dianhydride monomer, and the method may further comprise, after step (b), a step of (c) imidizing the polyamic acid to prepare a polyimide.

In step (c), a dehydrating agent and a catalyst may be added to the polyamic acid in order to imidize the polyamic acid. The dehydrating agent may be, but is not particularly limited to, any agent capable of promoting a ring closure reaction by dehydrating the polyamic acid. Examples of the dehydrating agent may include acetic anhydride, and the like. The catalyst may be, but is not particularly limited to, any catalyst capable of catalyzing the ring closure reaction for polyamic acid. Examples of the catalyst may include a tertiary amine, e.g., quinoline, isoquinoline (IQ), β-picoline (BP), and the like.

The imidization reaction performed in step (c) has an imidization rate of 97 to 100%, preferably 98 to 100%, more preferably 99 to 100%, and most preferably 100%.

The method may further comprise, after step (c), a step of (d) purifying, filtering, and drying the polyimide.

To purify the polyimide in step (d), the polyimide may be precipitated in a non-solvent to remove impurities. Examples of the non-solvent may include, but are not limited to, water, methanol, ethanol, n-propanol, isopropanol, butanol, butanediol, ethylene glycol, glycerol, gamma-butyrolactone, or mixtures thereof.

Further, the filtering may be performed by one or a combination of two or more of the following methods selected from the group consisting of gravity filtration, reduced pressure filtration, vacuum filtration, pressurized filtration, squeeze filtration, centrifugal filtration, microfiltration, ultrafiltration, and reverse osmosis methods.

In addition, the drying may be performed by one or a combination of two or more of the following methods selected from the group consisting of natural drying, pressurized drying, hot air drying, spray drying, film drying, vacuum drying, freeze drying, spray freeze drying, electromagnetic wave drying, and flash drying methods.

### Advantageous Effects of Invention

The polyimide according to the present disclosure has excellent soluble properties in an organic solvent, and at the same time has excellent thermal and mechanical properties.

Further, the polyimide according to the present disclosure may be fully imidized and may be prepared in various ways, such as films and fibers, etc., simply by drying a solvent without an imidization process at high temperature, thereby improving the ease of processing.

In addition, the polyimide according to the present disclosure may be applicable to various fields such as separators (membranes), binders, insulation coatings, coating materials, fibers, etc.

### BRIEF DESCRIPTION OF DRAWINGS

FIG. 1 shows the results of the solubility evaluation in an organic solvent of polyimides prepared according to Examples 1, 2 and Comparative Example 1.

### BEST MODE FOR CARRYING OUT THE INVENTION

The following Examples are presented to help understanding of the present disclosure. The following examples are only provided to more easily understand the present disclosure, but the content of the present disclosure is not limited by these Examples.

### EXAMPLE

### Example 1: Preparation of Polyimide

In nitrogen/room temperature atmosphere, 5 mol % of 4,4′-methylenebis(2,6-diethylaniline) (MEDA) and 95 mol % of 2,4-diaminotoluene (2,4-TDA) were dissolved in dimethylformamide (DMF) organic solvent. Then, 100 mol % of 3,3′,4,4′-benzophenone tetracarboxylic dianhydride (BTDA) was added, followed by random polymerization with MEDA, 2,4-TDA and BTDA for 1 hour to obtain a polyamic acid composition.

To the obtained polyamic acid composition, a tertiary catalyst (betapicoline, BP) and a dehydrating agent (acetic anhydride, AA) were added, and the resulting mixture was subjected to a chemical imidization process in a continuous polymerization batch process at 60 °C. Next, after completion of the reaction, the polymer was precipitated in an ethanol non-solvent to remove impurities (unreacted products, tertiary catalysts, AA, etc.) and dried in a vacuum oven at a temperature of less than 150 °C for 24 hours to prepare polyimide powder (solid content of 20 wt %).

### Example 2: Preparation of Polyimide

The polyimide powder was prepared in the same manner as in Example 1, except that instead of using 5 mol % of methylenebis(2,6-diethylaniline) (MEDA) and 95 mol % of 2,4-diaminotoluene (2,4-TDA) in Example 1, 10 mol % of methylenebis(2,6-diethylaniline) (MEDA) and 90 mol % of 2,4-diaminotoluene (2,4-TDA) were used.

### Comparative Example 1: Preparation of Polyimide

In nitrogen/room temperature atmosphere, 5 mol % of 4,4′-methylenebis(2,6-diethylaniline) (MEDA) was dissolved in dimethylformamide (DMF) organic solvent, and 100 mol % of 3,3′,4,4′-benzophenone tetracarboxylic dianhydride (BTDA) was then added, followed by block polymerization for 1 hour. Then, 95 mol % of 2,4-diaminotoluene (2,4-TDA) was added and block polymerized for 1 hour to obtain a polyamic acid composition.

To the obtained polyamic acid composition, a tertiary catalyst (betapicoline, BP) and a dehydrating agent (acetic anhydride, AA) were added, and the resulting mixture was subjected to a chemical imidization process in a continuous polymerization batch process at 60 °C. Next, after completion of the reaction, the polymer was precipitated in an ethanol non-solvent to remove impurities (unreacted products, tertiary catalysts, AA, etc.) and dried in a vacuum oven at a temperature of less than 150 °C for 24 hours to prepare polyimide powder (solid content of 20 wt %).

The monomer components, amounts, polymerization methods, etc., of Examples 1, 2 and Comparative Example 1 are listed in Table 1 below. In Table 1 below, the viscosity was measured at a temperature of 23 °C and a shear rate of 1s⁻¹, and the molecular weight was determined using gel chromatography (GPC). In Table 1 below, the polymerization viscosity of PAA refers to the viscosity of the polyamic acid composition, the PAA molecular weight refers to the molecular weight of the polyamic acid composition, the 20 wt % re-dissolution viscosity refers to the viscosity of polyimide powder (solid content of 20 wt %) re-dissolved in an organic solvent, and the re-dissolved PI molecular weight refers to the molecular weight of polyimide powder (solid content of 20 wt %) re-dissolved in an organic solvent.

TABLE 1

| | | | | | Comparative | |
|---|---|---|---|---|---|---|
| | Example 1 | | Example 2 | | Example 1 | |
| Dianhydride | BTDA (100 mol %) | | | | | |
| Diamine 1 | MEDA (5 mol %) | | MEDA (10 mol %) | | MEDA (5 mol %) | |
| Diamine 2 | 2,4-TDA | | 2,4-TDA | | 2,4-TDA | |
| | (95 mol %) | | (90 mol %) | | (95 mol %) | |
| Solvent | DMF | | | | | |
| Polymeri- | Random polymerization | | | | Block | |
| zation | | | | | polymerization | |
| Method | | | | | | |
| Input order | Diamines 1 + 2 -> Dianhydride | | | | Diamine 1 -> | |
| | (1 h) | | | | Dianhydride | |
| | | | | | (1 h) -> Diamine | |
| | | | | | 2 (1 h) | |
| Solid content | 20 wt % | | | | | |
| PAA | 820 | cP | 306 | cP | 283 | cP |
| polymeri- | | | | | | |
| zation | | | | | | |
| viscosity | | | | | | |
| PAA | 121,500 | g/mol | 51,000 | g/mol | 58,700 | g/mol |
| molecular | | | | | | |
| weight (Mw) | | | | | | |
| 20 wt % Re- | 6,025 | cP | 807 | cP | — | |
| dissolution | | | | | | |
| viscosity | | | | | | |
| Re-dissolved | 80,600 | g/mol | 51,595 | g/mol | — | |
| PI molecular | | | | | | |
| weight | | | | | | |
| (Mw) | | | | | | |

### Example 3: Preparation of Polyimide Film

The polyimide powder prepared according to Example 1 was dissolved in an organic solvent (DMF) to obtain a solution containing 20 wt % solid content, and the thus obtained solution was coated on a glass substrate to a thickness of 20 μm using a spin coater (MS-B200, Mikasa) and dried at 250 °C for 20 minutes. Here, the coating method is not particularly limited. Then, the resulting product was cooled at 25 °C and separated from the glass substrate, thereby preparing a polyimide film with a thickness of about 20 μm.

### Example 4: Preparation of Polyimide Film

The polyimide film was prepared in the same manner as in Example 3 except that instead of using the polyimide powder prepared according to Example 1, the polyimide powder prepared according to Example 2 was used.

### Comparative Example 3: Preparation of Polyimide Film

The polyimide film was prepared in the same manner as in Example 3 except that instead of using the polyimide powder prepared according to Example 1, the polyimide powder prepared according to Comparative Example 1 was used.

### Experimental Examples

### Experimental Example 1: Evaluation of Solubility

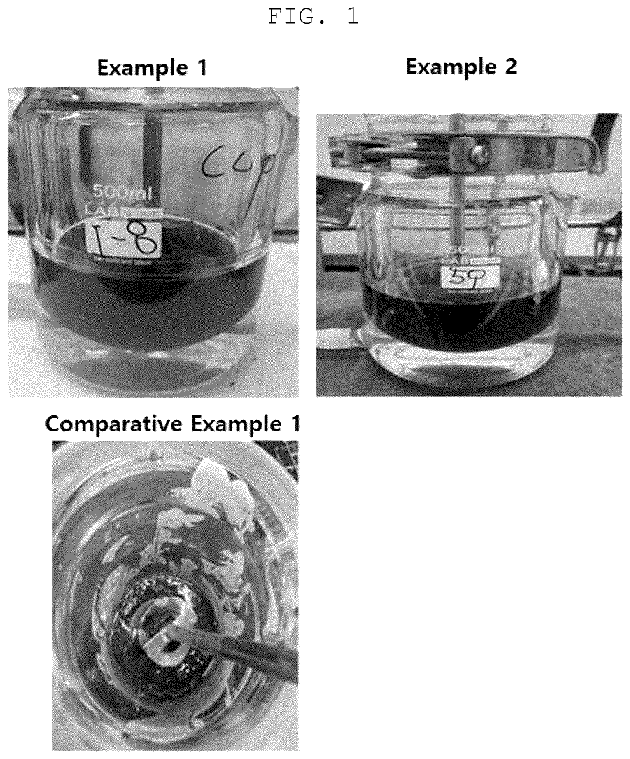

The solubility of polyimide in an organic solvent was evaluated by adding 20 g of polyimide powder each prepared according to Examples 1 and 2 and Comparative Example 1 into 80 g of organic solvent, N,N′-dimethylformamide (DMF), and visually confirming the solution. Specifically, 20 wt % of polyimide solid content was added thereto at room temperature, then the solution was stirred for 30 minutes, and the degree of turbidity of the solution was confirmed visually. Results thereof are shown in FIG. 1.

As shown in FIG. 1, it could be confirmed in Examples 1 and 2 that the polyimides were well soluble in the organic solvent without floating matters and had soluble properties. Comparative Example 1, on the other hand, showed floating matters and was poorly soluble in the organic solvent.

In other words, the polyimides according to Example 1 and Comparative Example 1 have the same composition, but it could be appreciated that the soluble properties of Example 1 could be implemented by randomly arranging the polymerized units, unlike Comparative Example 1 having a regular arrangement of polymerized units. Thus, according to the present disclosure, it was possible to achieve solubility while reducing the MEDA to at least 5 mol %, by randomly arranging the polymerized units.

### Experimental Example 2: Evaluation of Glass Transition Temperature (Tg)

For each polyimide film prepared according to Examples 3 and 4 and Comparative Example 3, the point at which the polyimide rapidly expands at 5 °C/min was measured as the on-set point using dynamic mechanical analysis (DMA). Results thereof are shown in Table 2.

### Experimental Example 3: Evaluation of Thermal Decomposition Temperature (Td) at 5% Weight Loss

TA's thermogravimetric analyzer Q50 was used, and each polyimide prepared according to Examples 3 and 4 and Comparative Example 3 was heated up to 100 °C at a rate of 10 °C/min under a nitrogen atmosphere and then maintained isothermally for 1 hour to remove moisture. Then, the temperature at which a 5% weight loss occurred by heating up to 600 °C at a rate of 10 °C/min was measured. Results thereof are shown in Table 2 below.

Table 2 below shows results of the solubility, glass transition temperature (Tg), and thermal decomposition temperature (Td) at 5% weight loss of the polyimides prepared according to Examples 3 and 4 and Comparative Example 3.

TABLE 2

| | | | Comparative |
|---|---|---|---|
| Polyimide film | Example 3 | Example 4 | Example 3 |
| Glass | 326 °C | 319 °C | — |
| transition | | | |
| temperature | | | |
| (Tg) | | | |
| Thermal | 505 °C | 497 °C | — |
| decomposition | | | |
| temperature | | | |
| (Td) at 5% | | | |
| weight loss | | | |
| Solubility | soluble | soluble | non soluble |
| (solvent | | | |
| solubility) | | | |

It could be confirmed from Table 2 that the polyimide films (random polymerization) according to Examples 3 and 4 not only had excellent solubility in DMF, an aprotic polar organic solvent, but also maintained excellent thermal properties. Comparative Example 3, on the other hand, was unable to implement a film because the polyimide powder (block polymerization) of Comparative Example 1 was insoluble in the organic solvent.

From these results, by randomly arranging the polymerized units and reducing the MEDA amount to 10 mol % and 5 mol %, it was possible to implement soluble properties for aprotic polar organic solvents (e.g., DMF) and also improve the heat resistance properties (Tg and Td 5 wt %).

In the specification, details capable of being sufficiently recognized and inferred by those skilled in the art of the present disclosure are omitted, and various modifications can be made within the scope that does not change the technical spirit or essential configuration of the present disclosure other than the specific examples described in the present specification. Therefore, the present disclosure may be practiced in other ways than specifically described and exemplified herein, which can be understood by those skilled in the art.

1. A polyimide comprising: as polymerized units,
a dianhydride monomer; and
a diamine monomer including 4,4′-methylenebis(2,6-diethylaniline) (MEDA),
wherein the polyimide is a random copolymer in which the polymerized units are irregularly arranged.

2. The polyimide of claim 1, wherein the dianhydride monomer comprises at least one selected from the group consisting of 3,3′,4,4′-benzophenone tetracarboxylic dianhydride (BTDA), oxydiphthalic dianhydride (ODPA), 4,4′-(hexafluoroisopropylidene)diphthalic anhydride (6FDA), biphenyltetracarboxylic dianhydride (BPDA), and 3,3′,4,4′-diphenylsulfone tetracarboxylic dianhydride (DSDA).

3. The polyimide of claim 1, wherein the diamine monomer further includes at least one selected from the group consisting of 2,4-diaminotoluene (2,4-TDA), 2,6-diaminotoluene (2,6-TDA), m-phenylenediamine (m-PD), and p-phenylenediamine (p-PD).

4. The polyimide of claim 1, wherein an amount of the 4,4′-methylenebis(2,6-diethylaniline) (MEDA) in the total diamine monomers is more than 0 mol % and less than or equal to 15 mol %.

5. The polyimide of claim 3, wherein an amount of the 2,4-diaminotoluene (2,4-TDA) in the total diamine monomers is 85 mol % or more and less than 100 mol %.

6-15. (canceled)

16. The polyimide of claim 1,
wherein the polyimide comprises, as polymerized units,
the dianhydride monomer, 3,3′,4,4′-benzophenone tetracarboxylic dianhydride (BTDA); and
the diamine monomers, 4,4′-methylenebis(2,6-diethylaniline) (MEDA) and 2,4-diaminotoluene (2,4-TDA).

17. The polyimide of claim 1, wherein the polyimide exhibits soluble properties in an organic solvent for a solid content of 15 wt % or more.

18. The polyimide of claim 17, wherein the organic solvent comprises at least one selected from the group consisting of N-methyl-pyrrolidone (NMP), N,N′-dimethylformamide (DMF), N,N′-diethylformamide (DEF), N,N′-dimethylacetamide (DMAc), dimethylpropanamide (DMPA), and N,N-diethylacetamide (DEAc).

19. The polyimide of claim 1, wherein a thermal decomposition temperature (Td) at 5% weight loss of the polyimide is 485 °C or higher.

20. The polyimide of claim 1, wherein a glass transition temperature (Tg) of the polyimide is 300 °C or higher.

21. The polyimide of claim 1, wherein a tensile strength of the polyimide is 90 MPa or more,
a modulus of the polyimide is 2.5 GPa or more,
an elongation of the polyimide is 3.5% or more.

22. A polyimide film comprising the polyimide according to claim 1.

23. A method for preparing a polyimide comprising:
(a) adding a dianhydride monomer to a diamine monomer including 4,4′-methylenebis(2,6-diethylaniline) (MEDA); and
(b) performing random-polymerization on the diamine monomer and the dianhydride monomer.

24. The method of claim 23, wherein the dianhydride monomer comprises at least one selected from the group consisting of 3,3′,4,4′-benzophenone tetracarboxylic dianhydride (BTDA), oxydiphthalic dianhydride (ODPA), 4,4′-(hexafluoroisopropylidene)diphthalic anhydride (6FDA), biphenyltetracarboxylic dianhydride (BPDA), and 3,3′,4,4′-diphenylsulfone tetracarboxylic dianhydride (DSDA).

25. The method of claim 23, wherein the diamine monomer further includes at least one selected from the group consisting of 2,4-diaminotoluene (2,4-TDA), 2,6-diaminotoluene (2,6-TDA), m-phenylenediamine (m-PD), and p-phenylenediamine (p-PD).

26. The method of claim 23, wherein the polyimide comprising: as polymerized units,
a dianhydride monomer; and
a diamine monomer including 4,4′-methylenebis(2,6-diethylaniline) (MEDA),
wherein the polyimide is a random copolymer in which the polymerized units are irregularly arranged.

27. The method of claim 23, wherein the polyimide comprises, as polymerized units,
the dianhydride monomer, 3,3′,4,4′-benzophenone tetracarboxylic dianhydride (BTDA); and
the diamine monomers, 4,4′-methylenebis(2,6-diethylaniline) (MEDA) and 2,4-diaminotoluene (2,4-TDA).

28. The method of claim 23, wherein the step (a) comprises:
(a-1) dissolving a diamine monomer including 4,4′-methylenebis(2,6-diethylaniline) (MEDA) in an organic solvent; and
(a-2) adding a dianhydride monomer to the dissolved diamine monomer.

29. The method of claim 23, wherein the step (b) is performed for 10 to 120 minutes.

30. The method of claim 23, wherein in step (b), the polyamic acid is prepared by polymerizing the diamine monomer and the dianhydride monomer, and the method further comprises, after step (b), a step (c) of imidizing the polyamic acid to prepare a polyimide.
